(19) United States
(12) Patent Application Publication
(10) Pub. No.: US 2005/0249347 A1
(43) Pub. Date: Nov. 10, 2005

(54) Non stationary echo canceller

(75) Inventors: Rene Martinus Maria Derkx, Eindhoven (NL); Ivo Leon Diane Marie Merks, Eindhoven (NL); Cornelis Pieter Janse, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., BA Eindhoven (NL)

(21) Appl. No.: 10/517,911

(22) PCT Filed: May 27, 2003
(86) PCT No.: PCT/IB03/02275

§ 371 Date: Dec. 14, 2004

(30) Foreign Application Priority Data
Jun. 19, 2002 (EP) 02077430.3

(51) Int. Cl. H04M 9/08

(52) U.S. Cl. 379/406.06; 379/406.01

(57) ABSTRACT

An echo canceller (1) is described, which has dedicated non stationary echo cancelling properties. The non stationary echo could be estimated directly, or indirectly by subtracting the stationary echo determined by a stationary noise estimator. The echo canceller may comprise an adaptive filter (4) and a residual echo processor (6) coupled to the adaptive filter, which residual echo processor is equipped with the non stationary echo canceller. Such a non stationary echo canceller is proposed in order to prevent the stationary component in the echo estimate, especially in the residual echo from continuously distorting near end speech. This improves echo canceller performance in terms of speech quality and speech intelligibility, which is particularly important in cases of single talk near end speech, as opposed to double talk.

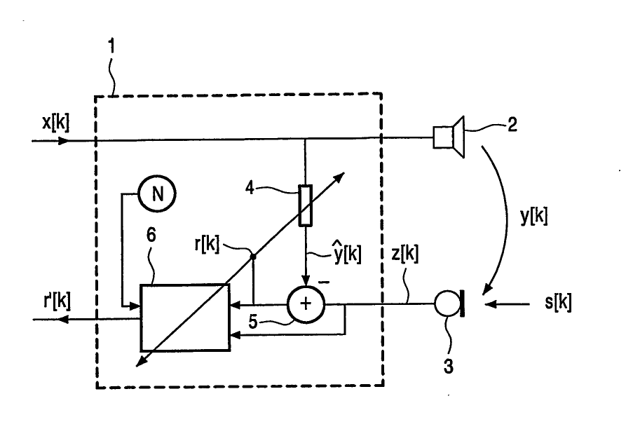

The present invention relates to an echo canceller, and a communication device.

The present invention also relates to a method for cancelling echoes in a communication network comprising one or more communication devices, such as for example a speakerphone or teleconferencing device, a telephone device, in particular a mobile telephone, a hands-free telephone or the like, and relates to signals suitable for use in the method.

Such an echo canceller and echo cancelling method are known from WO97/45995 (=EP-A-0843934). The known echo canceller has a far end input and output pair, and a near end input and output pair, the latter pair being coupled to a microphone and a loudspeaker respectively. The echo canceller further comprises an adaptive filter coupled to the far end input for receiving a signal from the far end, and a residual echo processor coupled to the adaptive filter and to the far end output, which provides a signal to the far end. The residual echo processor acts as a dynamic echo post processor for suppressing a residual echo tail part. It improves robustness of the echo cancelling method.

The inventors found that the prior art echo canceller does not operate optimal under all circumstances.

Therefore it is an object of the present invention to further improve echo canceller performance in terms of quality and intelligibility.

Thereto the echo canceller according to the invention is characterised in that the echo canceller comprises a dedicated non stationary echo canceller.

Similarly the method according to the invention is characterised in that non stationary echoes are being cancelled by post processing.

It is found to be important to distinguish stationary from non stationary echoes, especially when it concerns quality and intelligibility during near end single talk. In those situations where a signal from the far end comprises a stationary echo component and where there exists a large direct coupling between the near end loudspeaker and microphone, particularly when the near end speaker signal is relatively weak, such as when the speaker is far away from the microphone, the near end signal is distorted. This distortion is due to the stationary echo component included in the far end signal. The effects of the distortion on quality and intelligibility of the near end signal depends on the actual situation of double talk or single talk of the near end speaker. During double talk in a conversation these distortions are generally acceptable, as double talk arises in cases of a wanted interruption in the conversation, were quality is of less importance. However single talk of the near end speaker requires highest signal quality, which should not be distorted by the echo cancelling and attenuation effects due to stationary echoes from the far end. With this notion a dedicated non stationary echo canceller is proposed in order to prevent the stationary component in the echo, especially in the residual echo to continuously distort near end speech. This improves echo canceller performance in terms of quality and intelligibility.

An embodiment of the echo canceller according to the invention has the characterising features outlined in claim 2.

Alternatively the non stationary echo canceller may comprises a stationary echo estimator and/or a non stationary echo estimator. In the former case the non stationary echo component follows indirectly from subtracting the stationary echo component from the full or prior art echo modelled by the echo canceller, whereas in the latter case the non stationary echo component is directly available.

A further embodiment of the echo canceller according to the invention has the characterising features outlined in claim 3.

Because the stationary echo component reveals itself as noise the stationary echo estimator may advantageously be embodied by a relative simple to implement stationary noise estimator. In particular electrical noise as source of stationary annoying echoes can accurately be estimated this way.

Further, in an embodiment outlined in claim 4, the stationary noise estimator operation may be based on well known minimum statistics applied in spectral subtraction.

A still further embodiment of the echo canceller according to the invention is outlined in claim 5.

The architecture of the echo canceller links up well with and only needs small adjustments to an echo canceller comprising an adaptive filter and a residual echo processor coupled to the adaptive filter, whereby the residual echo processor is now equipped with such a non stationary echo canceller.

Another embodiment of the echo canceller according to the invention is outlined in claim 6.

Introduction of comfort noise in particular in the far end echo canceller advantageously mitigates problems arising from the fact that some acoustical noise originates from a centre clipper positioned at the far end. The centre clipper will frequently clip the acoustical noise, leading to silent periods in the far end signal. This in turn leads to very strong non stationarities which can not be dealt with adequately by the non stationary echo canceller. The combination of these non stationarities with some introduced comfort noise allows the echo canceller according to the invention to deal therewith more adequately.

At present the echo canceller and associated echo cancelling method according to the invention will be elucidated further together with their additional advantages, while reference is being made to the appended sole FIGURE showing a general outline of a full duplex echo canceller according to the invention, which is provided with a residual echo processor, which processor comprises a non stationary echo canceller.

The sole FIGURE shows a general outline of an Acoustic Echo Canceller, or AEC 1. Such an AEC 1 is an important component in nowadays mostly full duplex communication devices, such as for example a speakerphone device, teleconferencing device, a telephone device, in particular a mobile telephone, a hands-free telephone or the like. In modern handsets, where a loudspeaker 2 and a microphone 3 are coupled to the AEC 1 and generally are mounted very close together, such an AEC removes annoying echoes. The same applies for a teleconference device where mostly one or more loudspeakers and microphones are coupled to the AEC 1.

The FIGURE shows a signal x[k] coming from a far end side, which signal is reproduced by the loudspeaker 2 at the near end side. The index k indicates that the signal x is sampled. Apart from a signal s[k] mainly originating from the near end speaker the microphone 3 also senses a signal y[k] comprising a reverberated far end echo generated by the loudspeaker 2. So for a microphone signal z[k] at the near end it holds that z[k]=s[k]+y[k]. The AEC 1 operates by means of an adaptive filter 4 to generate a signal r[k], which does not include the echo signal y[k]. Ideally the signal r[k], which may be the output signal of the AEC 1, only comprises the local near end signal s[k]. Thereto the adaptive filter 4 estimates the echo, which estimate is represented by the signal ŷ[k]. In fact the adaptive filter 4 models the acoustic path from the loudspeaker 2 to the microphone 3 as good as possible. Subtracting ŷ[k] from z[k] in subtractor 5 reveals the output signal r[k]. It is noted that two AEC's are required at the far end and at the near end in a communication device or communication network.

The AEC's 1 operation may be extended by including a residual echo processor 6 therein. In that case the signal r′[k] is the output signal of the AEC 1. In practice the adaptive filter 4 is not always able to accurately model the transfer function of the acoustic path between the loudspeaker 2 and the microphone 3 due to its finite digital filter length, tracking problems and non linear effects. Processor 6 being a post processor has the important advantage that it provides sufficient echo suppression and robustness at all times. The output signal of the echo post processor 6 indicated r′[k] is coupled to the far end. The post processor 6 which like the adaptive filter 4 generally acts in the frequency domain has the further advantage that it does not require the AEC 1 to have a double talk detector and/or a voice activity detector in order to operate properly. Its operation which is considered to be known can for example be taken from EP-A-0 843 934, whose disclosure is supposed to be include here be reference thereto. Principally the AEC 1 may be of an arbitrary adaptive filter type, wherein amplitude or power based echo suppression may be applied with any suitable algorithm. Examples of suitable algorithms for adjusting coefficients of the echo canceller are: the Least Mean Square (LMS) or Normalised LMS algorithm, or the Recursive Least Square (RLS) algorithm.

In order to prevent stationary echo components to attenuate the near end speech signal s[k] echo cancelling performed on the remaining or tail part of the echo is restricted to non stationary echo cancelling. By non stationary as opposed to stationary it is meant that in this case the spectral properties—that is both shape and amplitude—of the echo do not alter substantially over time. By introducing such non stationary echo cancelling the stationary component in the echo is no longer able to continuously distort and attenuate near end speech, which improves speech quality and speech intelligibility. The improvement is particularly significant in a near end single talk situation.

In practice the echo canceller comprises a non stationary echo canceller, such that the improvement above will be reached. In view of the mentioned important advantages which a post processor 6 has, it will for reasons of simplicity be assumed that the non stationary echo canceller is mainly included in the post processor 6.

The post processor 6 processes frames of B samples and performs the processing in the spectral magnitude domain. The spectral magnitude of the microphone signal z[k] and residual signal r[k] in a certain frequency bin f and data frame 1_{B} is hereafter indicated with |Z(f; 1_{B})| and |R(f; 1_{B}| respectively. γ is called the echo subtraction factor, which typically is slightly larger than 1. |Ŷ(f; 1_{B})| denotes the spectral magnitude estimate of the echo signal. Generally this estimate can be obtained by means of a-priori knowledge of the adaptive filter output, which estimate can be improved further by using assumptions about the acoustic path to be modeled, such as exponential decay and non linear distortions. Instead of using |Ŷ(f; 1_{B})| it is proposed to use |Ŷnon stat(f; 1_{B})|, such that only non stationary echoes are being suppressed. The well known frequency dependent attenuation function A(f; 1_{B}) here implemented in the post processor 6, then becomes for all frequencies:
A(f;1_{B})=max{(|Z(f;1_{B})|−γ|Ŷnon stat(f;1_{B})|)/|R(f;1_{B}),0}.
Herein |Ŷnon stat(f; 1_{B})| could be estimated by means of some non stationary echo estimator or by means of subtracting |Ŷ(f; 1_{B})| from |Ŷstat(f; 1_{B})|, where the latter is the stationary echo component of the former full echo estimate. The latter echo estimate could be obtained by means of some arbitrary algorithm for stationary background noise estimation. An example thereof using minimum statistics, can be found in an article entitled: “Spectral Subtraction Based on Minimum Statistics”, by R. Martin, published in Signal Processing VII, Proc. EUSIPCO, pages 1182-1185, Edinburgh (Scotland, UK), September 1994, whose disclosure is considered included here by reference thereto.

It is noted here that if A(f; 1_{B})>1 for some frequency component, A(f; 1_{B}) is set to 1. Thus in frequency bands with a strong far end echo compared with the near end signal, the post processor 6 attenuates the echo tail part, and in frequency bands where the near end signal is much stronger than the far end echo no attenuation is applied on the echo tail part. After post processing the resulting output signal r′[k] is acquired by transforming the attenuated signal back to the time domain and adding the original phase of r[k] thereto.

In some cases it is advisable to include comfort noise inserting means N in the echo canceller 1, such as in cases wherein a centre clipper is applied therein. This mitigates the effects of very strong non stationarities. It also smoothes the operation of the echo cancelling process. The noise inserting means N may for example be coupled to the post processor 6.

Whilst the above has been described with reference to essentially preferred embodiments and best possible modes it will be understood that these embodiments are by no means to be construed as limiting examples of the echo canceller, communication devices and method concerned, because various modifications, features and combination of features falling within the scope of the appended claims are now within reach of the skilled person.

1. An echo canceller, characterised in that the echo canceller comprises a dedicated non stationary echo canceller.

2. The echo canceller according to claim 1, characterised in that the non stationary echo canceller comprises a stationary echo estimator and/or a non stationary echo estimator.

3. The echo canceller according to claim 2, characterised in that the stationary echo estimator is a stationary noise estimator.

4. The echo canceller according to claim 3, characterised in that the stationary noise estimator is based on minimum statistics.

5. The echo canceller according to claim 1, characterised in that the echo canceller comprises an adaptive filter and a residual echo processor coupled to the adaptive filter, which residual echo processor is equipped with the non stationary echo canceller.

6. The echo canceller according to claim 1, characterised in that the echo canceller comprises comfort noise inserting means.

7. A communication device, such as for example a speakerphone or teleconferencing device, a telephone device, in particular a mobile telephone, a hands-free telephone or the like, characterised in that the communication device comprises one or more echo cancellers according to claim 1.

8. A method for cancelling echoes in a communication network comprising one or more communication devices according to claim 7, characterised in that non stationary echoes are being cancelled by post processing.

9. Signals suitable for use in the method according to claim 8, characterised in that the signals allow only non stationary echoes to be cancelled.
